(19) United States
(12) Patent Application Publication
(10) Pub. No.: US 2004/0143457 A1
(43) Pub. Date: Jul. 22, 2004

(54) Method and system for sharing personal health data

(76) Inventors: Vasken Demirian, Barton (AU); Philip Dibben, Barton (AU); Trevor Sinclair, Melbourne (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/471,625

(22) PCT Filed: Mar. 14, 2002
(86) PCT No.: PCT/AU02/00299

(30) Foreign Application Priority Data
Mar. 14, 2001 (AU) PR 3719

(51) Int. Cl. G06F 17/60

(52) U.S. Cl. 705/2

(57) ABSTRACT

The invention provides a method and system for a health care provider to obtain personal health data relating to a consumer. The system comprises a secure repository for the storage of a consumer's personal health data, and further comprises a template or the like enabling the consumer to select items of personal health data that are to be shared with a health care provider. The template also enables the consumer to identify the health care provider, or class of health care providers, to whom access will be provided for those selected items of personal health data. The system authenticates the identity of health care providers and provides access to the selected items of personal health data of the consumer for which the authenticated health care provider has been identified as having permission to access. The system further allows the health care provider to record details of the consultation in the consumer's secure repository of health data.

### TECHNICAL FIELD

This invention relates generally to a method and system for sharing the personal health data of a consumer and is particularly suited to a method and system that utilises the personal health data of a consumer to enable a suitably qualified health care provider to assess the condition of the consumer and to provide appropriate health care advice, products and/or services.

### BACKGROUND ART

Health care professionals require health information to provide appropriate health care advice to consumers. In most cases, accurate historical health data will enable a health care professional to provide better health care advice as compared with limited or inaccurate health information.

In particular, when prescribing medication to a consumer, an accurate record of past and present medication would provide to the prescribing health care professional information that may determine or alter their advice regarding medication or therapeutic procedures that should be undertaken. However, in most instances, prescribing health care professionals rely upon the advice provided by the consumer regarding their past medical history.

The pharmacy profession acts as an intermediary between the physician and patient for the purpose of dispensing medications and has developed business systems to record and effect those transactions.

In many countries, health care systems provide for subsidised medication for its population, with the process involving the submission of paper-based transaction records and the physical matching of those records by government sources for the purpose of effecting reimbursement.

To perform the dispensing function, the pharmacist currently relies upon presentation of a paper-based script for medication, often handwritten by a prescriber. In various instances, illegible handwriting has resulted in the dispensing of incorrect medications which in turn, has caused adverse interactions with other conditions or medications. Unintentional interactions have led to the hospitalisation of some consumers, and in rare cases the interaction has been fatal. Interactions and inaccurate dispensing of medication represents a significant cost to the community and a potential liability for health care professionals.

Community health is generally considered to be impeded as a result of limited access to consumers' health records. However, most individuals consider their personal health data to be private and do not wish those details to become publicly available. As an additional complication, individuals commonly deal with many health care professional service providers and because each health care professional is generally unable to access the complete health data of a consumer, providers may duplicate effort to provide their solutions and may be providing services and products inefficiently in attempting to improve the health of the individual.

When presented with a new condition or ailment requiring treatment, each service provider generally undertakes a new fact finding investigation. This investigation generally involves questioning the individual concerned and gaining an understanding of their medical history. This approach may lead to inaccurate or incomplete information as it is generally difficult for most individuals to remember their previous treatments and the precise time of receiving those treatments.

Manual intervention in pharmacy business processes also result in higher costs to consumers. For example, the submission of paper-based script to the government to seek reimbursement for subsidised medications is presently a substantially manual process. Such manual systems and methods require the pharmacy to commit internal resources to comply with government reporting requirements and impose burdens on cash flows for the pharmacist as he or she waits for reimbursement for medications.

Accordingly, it is advantageous to provide a method and system enabling health care professionals to integrate daily work-flow activities with access to consumer health data, and to provide a means for individuals to share their personal health data with suitably qualified health professionals from whom they seek a service. Additionally, it is advantageous to provide a method and system enabling individuals to selectively share personal health data with selected health professionals as part of an intervention plan to prevent, treat and/or manage a condition or ailment or the onset of a condition or ailment.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

In one aspect, the invention provides a method for a health care provider to obtain personal health data relating to a consumer, the method comprising the steps of:

the consumer causing personal health data to be stored in a secure repository, said repository requiring authentication of the consumer's identity before the consumer is provided access to the repository;

the consumer selecting items of personal health data to share and identifying a health care provider, or class of health care providers, to whom access will be provided for those items of personal health data;

a health care provider providing authentication of their identity to the consumer's secure repository and being provided access to those items of personal health data of the consumer for which the health care provider has been identified for sharing;

the health care provider using the personal health data of the consumer to determine health care advice or the provision of a health care service for the consumer; and

the health care provider recording details of the consultation and the advice or service provided to the consumer in the secure repository of health data of the consumer.

The selection of items of personal data for sharing may be effected by various methods. Preferably, the selection of items of personal health data for sharing is effected by use of a template, the template comprising at least one pre-defined list of personal health data items that may be shared with a health care provider, or class of health care providers. The pre-defined template may be amended by the consumer in order to alter the selection of items of personal health data that may be shared with health care providers identified by that template. For example, a consumer may wish to share certain types of personal health information with particular types of health care providers whereas they may not want to share that information with other types of health care provider.

The selection of personal health data for purposes of sharing may also be effected by use of a filter wherein a set of conditions satisfied by personal health data of the consumer is shared with a health care provider or class of health care provider. In instances where there is a substantial amount of personal health data, it may be more convenient to select items of personal health data for sharing by the establishment of a “sharing rule” or criteria as compared with requiring a consumer to provide a specific sharing indication for each and every item of personal health data they own.

Irrespective of the method used by a health care provider to gain access to personal health data items of a consumer, the method preferably comprises the step of recording all instances of actual access of the consumer's personal health data in order to generate an audit trail. The record of instances of access may be included in a report that is supplied to the consumer each and every instance an attempt to access personal health data occurs. Alternatively, a report of all instances of access of the consumer's personal health data may be provided on a regular basis (eg monthly).

In an embodiment, a consumer grants permission to a health care provider, such as a prescribing physician or health counsellor, to add and share items of personal health data by enabling that health care provider to access the template that the consumer has defined for that health care provider, or class of health care provider. In this instance, a physician may record the details of a prescription in the consumers health data repository, while a nominated pharmacist may gain access to the repository to retrieve and review the prescription. In any event, the authentication of the health care providers to gain access to the template may act as the authority to gain access to the items of personal health data of the consumer as provided for by the template.

Preferably, an individual's existing personal health data is prevented from being altered or deleted by either the consumer or parties granted access by the consumer. Although errors may occur from time to time, preferably where an error has been made to an entry an annotation recording the entry as erroneous is included in the health data.

Templates may define the particular items of personal health data that a consumer wishes to share but may also comprise other restrictions or conditions relating to the sharing of personal health data. For example, a template may operate to only allow access to personal health data for a limited period of time, or may only allow access for a limited number of times.

Whilst templates primarily limit access to specific items of personal health data intended to be shared by a consumer, they may also perform functions on the underlying personal health data of a consumer. This provides to the user of a template, information derived from one or more of the underlying items of personal health data. Additionally, a template may devolve medication and health information into data such that it may be presented to other users such as another health service provider in a more appropriate form. The devolution of personal health information into data thus provides greater flexibility with respect to the form of the personal health information required by other heath care providers.

In a preferred embodiment, the health care provider is a pharmacist and the health data comprises a list of medication that the consumer is currently prescribed and medication that has previously been prescribed. Upon approaching a pharmacist, the consumer may have already been prescribed medication for an ailment or condition and seeks to have the medication dispensed by the pharmacist.

Health care providers may contribute to the store of personal health data of a consumer as a result of effecting their own services in relation to the personal health data of the consumer for which they have been granted access. Thus, while the consumer has access to their own data and the health care provider has access to approved fields (as permitted by the consumer), both the consumer and health care provider may access and collaborate on the data in the interests of the consumer. For example, a pharmacist may develop a non smoking program for a consumer based upon their personal health data and may deposit into the consumers secure repository information relating to the non smoking program. The template provided to the health care provider, namely the pharmacist, may also provide them with the ability to deposit additional items of information into a consumer's repository such as educational information relating to new health services or facilities. Templates may be developed for specific purposes and be capable of only a single use.

In a particularly preferred embodiment, a health care provider may make available a software program which may be transferred into the secure repository of a consumer and may use the personal health data for which access has been granted as input to the software program. In this instance, the output of the software program also resides in the secure repository and is thus provided to the consumer. The output of the software program may, for example, provide advice to the consumer or may provide a progress report with respect to some combination of items of personal health data. The software program may provide an alert or warning of an impending condition or circumstance that requires some form of intervention in order to avoid. The software program may also provide details regarding the form of intervention required or choices in relation to the available types of intervention that may avoid the condition from developing. The delivery and execution of software within the secure repository of consumers provides an assurance to the consumer that their personal health data is not made available outside of their secure repository at any time.

The software program made available may also provide recommendations regarding further actions to be performed or further health data that should be collected or analysed in order to provide decision support. Preferably, consumer consent for this activity is required in advance.

The secure repository of items of personal health data of consumers may be entrusted to a third party. In a preferred embodiment, the entrusted third party may be engaged to create links between personal health data items of the consumer in order to enable other users to efficiently access required personal health data items of the consumer. In such an embodiment, the linking of items of health data may enable a health care provider to efficiently perform an analysis of a consumers relevant health data and to provide advice accordingly.

The repository of items of personal health data of consumers may be entrusted to a third party. Irrespective of the source or operation of the repository, access to health data within the repository preferably requires the use of a digital security key. The digital security key is preferably supplied at the time the health care provider requests access to items of personal health data, whether the access is by way of a template or not. The provision of access may be determined in a challenge/response manner.

In a particularly preferred embodiment, the health data repository is connected to a computer communications network thereby enabling all other permitted health care providers to connect to that network to gain access to the personal health data of a consumer. Preferably, the repository is connected to the Internet.

In an embodiment, the personal health data of a number of consumers may be provided concurrently to a health care provider. In this instance, a community of consumers is effectively formed wherein the secure repositories of the group of consumers are aggregated to form the community. This provides for the effective sharing of collective health information between that community of consumers and a health care provider and enables the provider to gather collective health information from the group and analyse that information.

In another aspect, the invention provides a system for a health care provider to obtain personal health data relating to a consumer, the system comprising:

a secure repository for the storage of a consumer's personal health data;

a means enabling the consumer to select items of personal health data that are to be shared with a health care provider, the means also enabling the consumer to identify the health care provider, or class of health care providers, to whom access will be provided for those selected items of personal health data;

means for authenticating the identity of health care providers and providing access to the selected items of personal health data of the consumer for which the health care provider has been identified as having permission to access; and

means for the health care provider to record details of the consultation in the consumer's secure repository of health data.

Preferably, the means for enabling the consumer to select items of personal health data to be shared with a health care provider comprises a user definable template which contains a list of items of personal health data that a consumer is likely to share with particular classes of health care provider. The user definable template may enable a consumer to indicate specific health care providers they wish to share items of personal health data with and the particular items of health data to be shared with that health care provider.

### BRIEF DESCRIPTION OF DRAWINGS

An example of the invention will now be described With reference to the accompanying drawings in which:

FIG. 1 is diagrammatic representation of the steps included in a preferred embodiment of the invention;

FIG. 2 is a diagrammatic representation of the steps included in the process of “Accepting prescription from consumer” for the embodiment of FIG. 1;

FIG. 3 is a diagrammatic representation of the steps included in the process of “Counselling consumer” for the embodiment of FIG. 1;

FIG. 4 is a diagrammatic representation of the steps included in the process of “Filling prescription and recording details” for the embodiment of FIG. 1;

FIG. 5 is a diagrammatic representation of the steps included in the process of “Handing over prescription and providing instructions” for the embodiment of FIG. 1; and

FIG. 6 is a diagrammatic representation of the steps included in the process of “Getting reimbursed” for the embodiment of FIG. 1.

### BEST MODE OF INVENTION

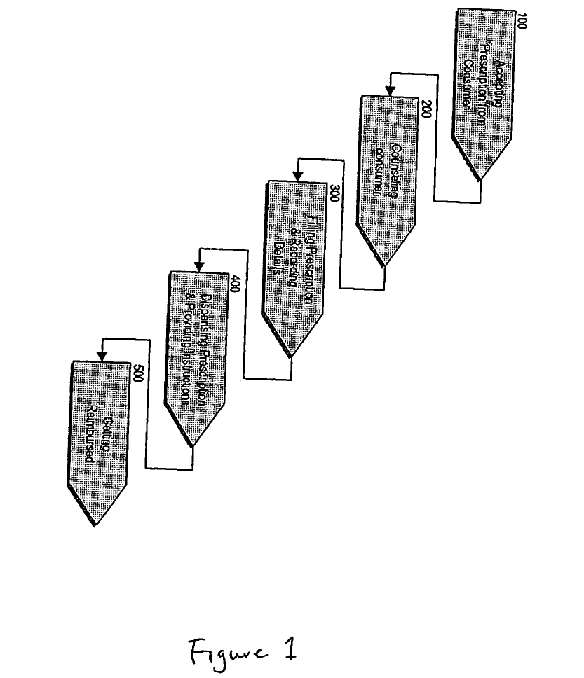

With reference to FIG. 1, the basic steps of an embodiment of the invention is depicted wherein the steps relate specifically to a method of dispensing pharmaceutical items to a consumer. In this embodiment, the personal health data, or health record, of a consumer includes a medication file that is retained in a secure repository.

The steps of a preferred embodiment of the present invention are depicted in a sequence as:—

1) Accepting the prescription from the consumer;

2) Counselling the consumer;

3) Filling the prescription and recording details;

4) Dispensing the prescription and providing instructions; and

5) Getting reimbursed.

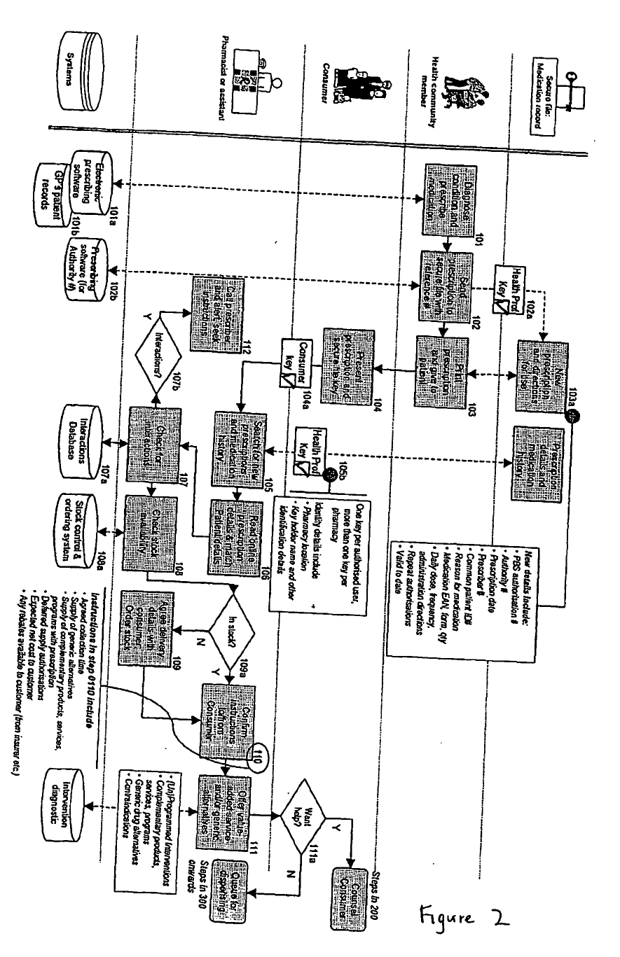

Each of the steps identified in FIG. 1 are further decomposed into their sub-ordinate steps and form FIGS. 2 to 6. All references below to the “pharmacist” may equally refer to an approved staff member.

In FIG. 1, Step 100 refers to the process of a consumer obtaining a prescription and presenting that prescription to a pharmacist. Step 200 involves counselling the consumer whilst Step 300 relates to the filling of the consumers prescription and the recording of the details of the prescription. Step 400 includes the various steps in dispensing the prescription and the provision of instructions on the part of the pharmacist. Finally, the method concludes with Step 500 which relates to reimbursement.

With reference to FIG. 2, in Step 101, a medical practitioner (“the prescriber”) diagnoses the consumer's condition and prescribes medication for treatment. This process is likely to be assisted by the practitioners patient records and an existing prescription software application (101a and 10 101b).

In Step 102, the prescriber sends a prescription, bearing a prescription reference number and other details to the consumer's secure medication file (103a). It is expected that suppliers of prescription software applications would modify their applications to include the step of issuing a prescription reference number. Access by a prescriber to the consumer's secure medication file will be permitted by use of a secure “challenge/response” authentication key (102a).

In Step 103, the prescriber prepares a hard copy of the prescription (with reference to the prescription details posted to the consumer's secure file in 103a), containing the reference number, and provides it to the consumer. This step may alternatively include the provision of a “smart card” identifier and authorisation device, which interfaces with the prescribers prescription software and records the relevant details.

In Step 104, the consumer presents the hard copy of the prescription to the pharmacist and their secure authentication key (104a).

In Step 105, the pharmacist enters the authentication key for that particular pharmacy and the prescription reference number into a digital code reading device (105b), and locates the consumer's prescription and medication history as recorded in a computer database system (105a). While the authentication key is required in various subsequent steps of the process, it is assumed that security checking and interaction will occur at each stage and that further entry of the key will not be required by the pharmacist or other pharmacy staff, unless the communication connection is broken and requires reestablishment.

In Step 106, the pharmacist reviews the details of the prescription and medication history held in the consumer's secure file. At Step 107, the prescription is submitted for analysis for any potentially adverse interactions (107b) with existing or prior medication prescribed to the consumer. It is expected that this analysis will be performed by accessing a database of pharmaceutical interactions (107a) at the time of reviewing the prescription and the consumer's medication history. This activity is repeated at Step 302. Assuming there are no potential adverse interactions, at Steps 108 and 109a, the pharmacist or staff member checks stock availability by reference to their automated stock control system (108a), or by performing a visual check.

At Step 109, if the medication is not in stock, the pharmacist or staff member agrees delivery times, locations and other details with the consumer. The pharmacy then proceeds to order the stock. If the medication is in stock, at Step 110, the pharmacist confirms a variety of instructions with the consumer. These are likely to include the collection time, the availability of generic alternatives, complimentary products or services, deferred supply authorisations, the expected net cost of the medication to the consumer and details of any available rebates.

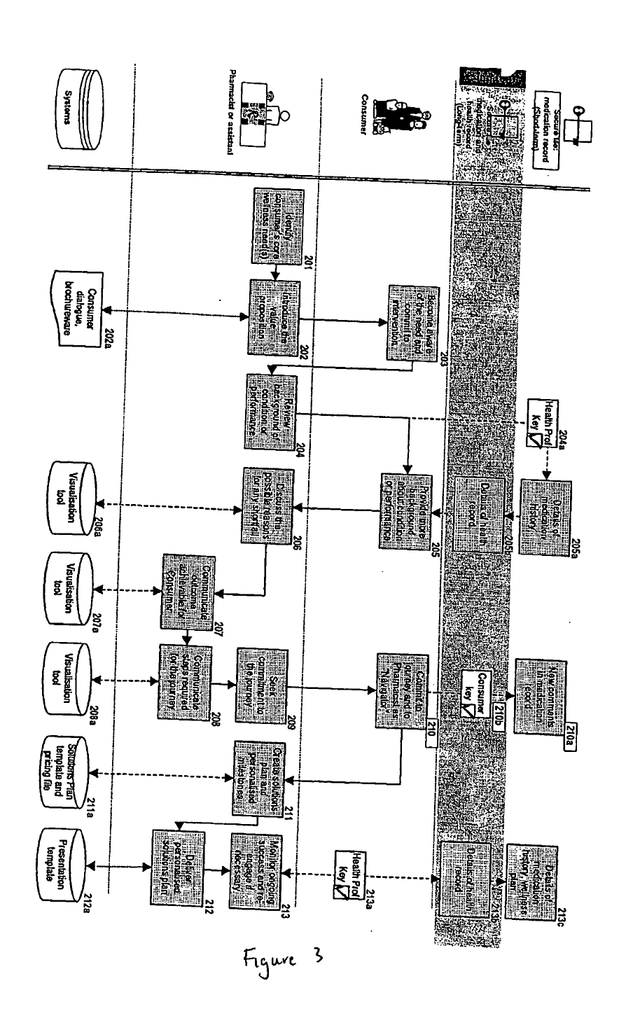

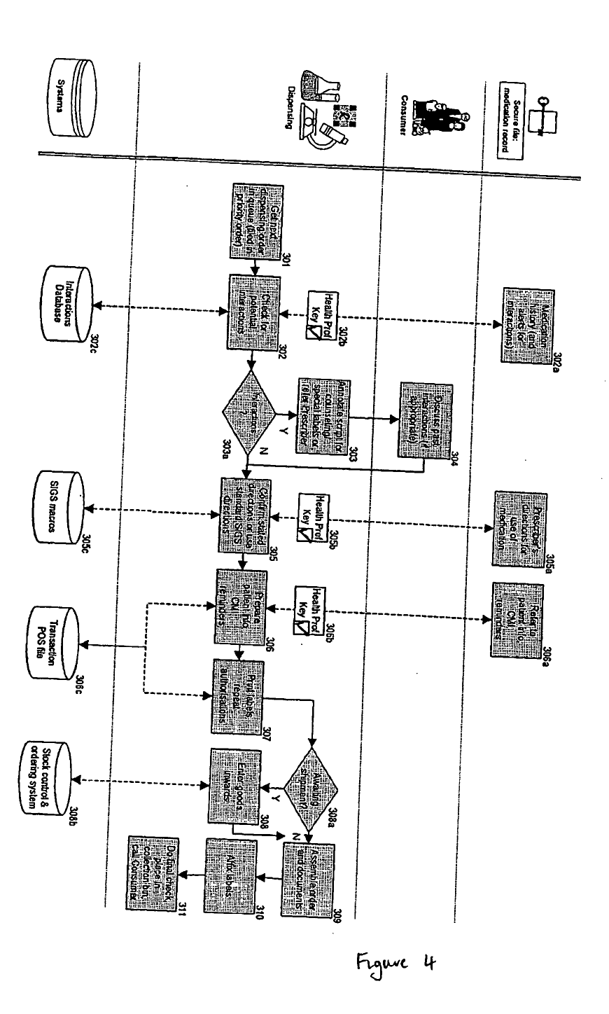

At Step 111, the pharmacist offers the consumer additional advice or information regarding generic alternatives to the prescribed medication. If the consumer wishes to receive the additional advice (111a), the consumer receives counselling, following the steps shown in FIG. 3. If the consumer does not wish to receive additional advice, the prescription is entered onto a processing queue referenced in FIG. 4.

Step 112 is executed if a potential pharmaceutical interaction is determined at Step 107. If potential interactions are detected, the pharmacist or staff member determine whether or not it is necessary to contact the prescriber and, if so, alerts them to the risk, and seeks instructions as to how to proceed. If not, the pharmacist provides the appropriate warning. Where a new prescription is required, the process recommences at Step 101.

FIG. 3 illustrates the counselling process by which pharmacists (or other professionals) provide additional advice to consumers.

In Step 201, the pharmacist meets with the consumer and identifies their concerns. This may be surrounding their asthma, cardiovascular, diabetes or other condition, for example.

In Step 202, the pharmacist introduces a proposition related to the desired goal in the form of an intervention program and delivers verbal or 12 written information (202a). At Step 203, the consumer becomes aware of the need, and the consumer and the pharmacist agree a program to which the consumer commits to achieve their established health goal.

In Step 204, the pharmacist and consumer discuss the background of the condition or past performance in other programs. Information in this regard will be contained in the consumer's medication record, accessed by the pharmacist's secure key (204a). Where permitted, further information will be provided through similar and concurrent access to the individual's health record.

At Step 205, the consumer and pharmacist review the relevant details contained in the individual's electronic records (the medication history in the short term in 205a, and the health record in the longer term as it is accepted by the community, in 205b).

In Step 206, the pharmacist provides more information about the condition or performance of treatment programs and alternatives, potentially using a visualisation tool (206a).

In Step 207 the pharmacist communicates the outcome achievable for the consumer, potentially using a visualisation tool (207a).

In Step 208, the pharmacist describes the activities and/or products available to assist the consumer in achieving their goal, using a visualisation tool (208a). For example, if the consumer intends to break their smoking habit, they may be offered assistance in the form of additional, over the counter, medication such as nicotine patches.

In Step 209, the pharmacist seeks the consumer's Commitment to the intervention program, which, if approved, is provided to the consumer at Step 210. The consumer enters the details of mutual commitment to this activity in their secure file (201a), using their secure access key (210b). Step 211 indicates the creation of a formal intervention plan. Some pharmacies may offer a formal plan indicating goals and personalised milestones, which may be created using a template and pricing file (211a). There may be a fee charged for this service, linked to a pricing schedule, or it may be offered as a free service.

The pharmacist delivers the plan at Step 212, possibly using a presentation template (212a).

At Step 213, the pharmacist monitors the ongoing success of the consumer in meeting planned milestones and goals. The monitoring of a 13 consumer's progress is preferably by way of continued access, using the secure access key (213a) to the consumer's private medication record which contains details of the consumer's progress in relation to an agreed intervention plan (213c). In the longer term, as the community accepts use 5 of a health record, this file is also accessed (in 213b).

FIG. 4 illustrates the processes for filling the prescription and recording transaction details.

At Step 301 the pharmacist retrieves the next prescription in the queue. In a busy pharmacy there may be a batch of prescriptions, or the pharmacist may simply note the order in which individuals arrive.

At Step 302 the pharmacist checks for potential interactions against both the consumer's medication record (302a), using a secure key (302b) for access and a medication interactions database (302c). In performing these checks, the pharmacist will also enter details regarding visual cues such as age, weight, sex, pregnancy and other factors. This step effectively duplicates Step 107, and acts as a double check thereby enhancing the accuracy and security of the process of checking for potential interactions. If potentially adverse interactions are detected, at Steps 303 and 303a, the pharmacist annotates the dispensing order for special counselling and the required container labels. The prescriber may be contacted, as in Step 107, to confirm their instructions in relation to the prescription or to represcribe. If potential interactions are detected, at Step 304 the pharmacist will make a note to discuss with the consumer any evidence of past interactions when they present to collect the medication.

At Step 305, the pharmacist will confirm the directions for medication use as stated by the prescriber against those contained in the database of macros for consumer directions (or SIGs, in 305c). The pharmacist will use their secure key (305b) to access the consumer's secure medication record, and note in the record any special instructions or comments added to the record in the past (305a).

At Step 306, the pharmacist prepares patient information, reminders and other documentation. Using their secure key (306b), the pharmacist may add information and reminders to the consumer's secure medication record (306a). Routines in the transactions work-flow software may generate this material (306c).

At Step 307, the pharmacist prints the labels and repeat authorisations (if applicable).

At Steps 308 and 308a, if medications were not in stock and an order was required, the pharmacist will receive and enter the goods into stock for distribution, and update the stock control and ordering system (308b).

At Step 309, the pharmacist assembles the order and all documents, and in Step 310, affixes all labels.

At Step 311, the pharmacist completes a final check of the dispensed order, places the order in a collection area and calls the consumer to advise the availability of their prescription for collection and payment.

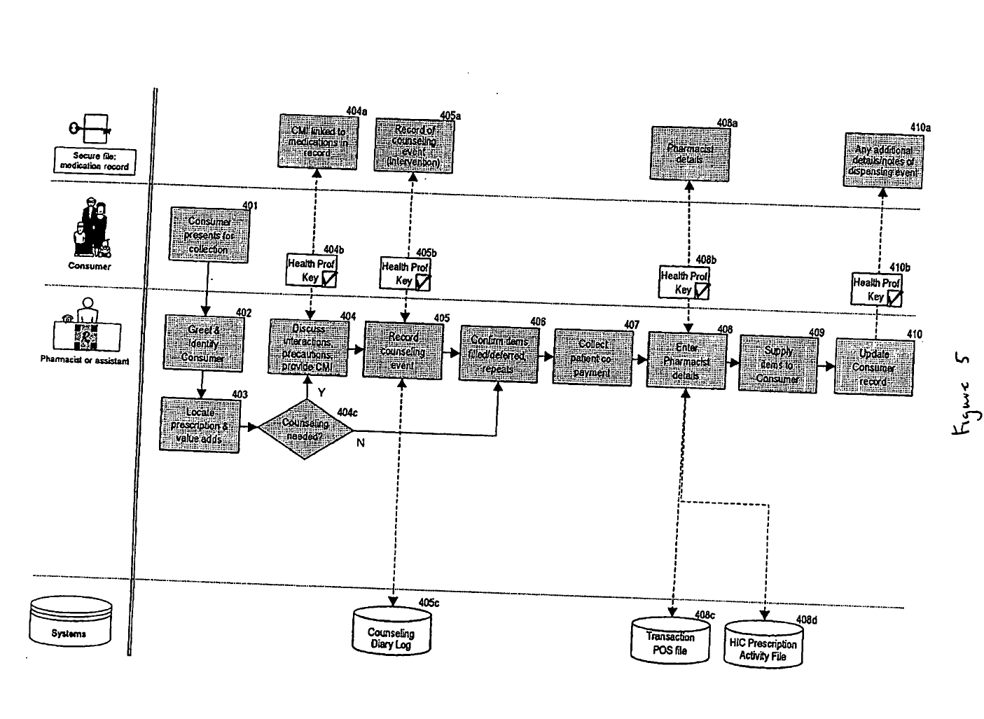

FIG. 5 illustrates the processes for handing over the prescription to the consumer and providing instructions.

At Step 401, the consumer arrives for collection of the medication. At this stage, the pharmacist greets and identifies the consumer, at Step 402. At Step 403, the pharmacist locates the prescription and any other items the consumer wishes to purchase.

At Steps 404 and 404c, if counselling is required as identified earlier at Step 303, the pharmacist advises in relation to potential interactions or precautions and delivers written Customer Medication Information (CMI) and other instructions, which presents this information in detail. This will be supported by details of CMI for medications currently being taken by the consumer, as evidenced in their secure medication record (404a), and accessed at the outset of the dispensing process, at Step 105, by the pharmacist using a secure key (404b).

At Step 405 the pharmacist records details of any counselling in the consumers secure medication record (405a), using their secure access key (405b).

At Step 406, the pharmacist confirms all prescriptions filled and deferred, against the details contained in the prescription documentation. At Step 407, the pharmacist receives co-payment for the medication from the consumer (this Step may occur after Step 409, depending upon individual pharmacy procedures).

At Step 408, the pharmacist confirms the details of the dispensing pharmacy in the consumer's secure medication record (408a, and as entered 35 earlier at Step 105), after gaining access with the pharmacy's secure access key (408b), and to the pharmacy's transaction POS file (408c).

This step may be automated with the relevant details provided by the pharmacy management and dispensing computer system. Details of the transaction are also recorded in the HIC Prescription Activity file, representing the file of dispensing activity sent to the Australian government's Health Insurance Commission on a regular basis for verification and reimbursement (408d). In Australia, the HIC is a Federal Government agency. It is to be appreciated that the present invention may apply to other such third party health insurance funds. Similarly, it is to be appreciated that health care providers as referred to in the present invention may comprise third party health insurers.

At Step 409, the dispensed items are supplied to the consumer. If appropriate, at Step 410 the pharmacist may gain access to the consumer's secure medication record using their secure key (410b), and add any information or notes relevant to the dispensing of the prescription (410a).

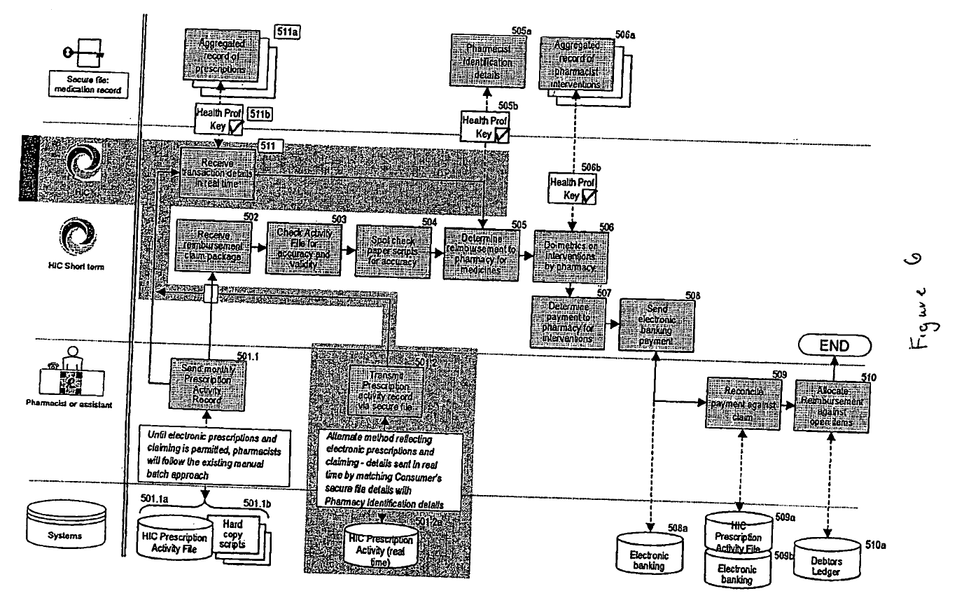

FIG. 6 illustrates the reimbursement process for the pharmacist for the cost of dispensed medications. Two alternative methods are illustrated, the first reflecting current legislation in Australia and the second based upon potential legislative changes allowing electronic submission of prescriptions (commencing at Steps 501.1 and 501.2 respectively).

At Step 501.1, the step reflecting current legislative restrictions, the pharmacy sends a batch of printed prescriptions (one for each transaction), along with a digital activity file of dispensing transactions occurring during the period (501.1a and 501.1b, respectively) to the HIC.

At Step 502, the HIC receives the claim package, and at Step 503, checks the activity file for accuracy and validity.

At Step 504, the HIC also spot checks randomly selected printed Prescriptions for accuracy and validity.

In the long term, it is anticipated that at Step 505, the HIC refers to the pharmacy's transaction details contained in aggregated secure medication files (505a), using its own secure key (505b), and determines the amount to be reimbursed to each pharmacy.

Again in the long term, at Step 506, the HIC quantifies the number of interventions undertaken by individual pharmacists, as recorded in the aggregated secure medication files (506a) after gaining access with their secure key (506b).

At Step 507, determines the payment to be made for interventions, such as for domiciliary medication reviews.

At Step 508, the HIC transmits electronic payment to the pharmacist's bank account, using an electronic banking program (Step 508a).

At Step 509, the pharmacist reconciles the HIC payment against his or her claim, referring to the HIC prescription activity file (509a) and the electronic banking advice (509b).

At Step 510, the pharmacist allocates HIC reimbursement against all open items, and makes the appropriate entries to their Debtors' Ledger (510a). It is expected that changes to legislation allowing the submission of electronic prescriptions between prescriber and pharmacist (rather than using a paper-based script) for each prescription will occur at some time in the future. At Step 501.2, the pharmacist, having captured all electronic prescriptions in their Prescription Activity file (501.2a), aggregates the records and transmits it to the HIC using a secure methodology for processing.

At Step 511, the receipt of the electronic transaction file is indicated, through access to an aggregated record of each pharmacy's prescriptions (511a) and through HIC access using their secure key (511a), bypassing the is manual checking processes and reverting back to Step 505.

Of course, appropriate steps would be included to accommodate the closing of a health record in the event of the death of a consumer or instructions from the consumer to close the record.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for a health care provider to obtain personal health data relating to a consumer, the method comprising the steps of:
the consumer causing personal health data to be stored in a secure repository, said repository requiring authentication of the consumers identity before the consumer is provided access to the repository;
the consumer selecting items of personal health data to share and identifying a health care provider, or class of health care providers, to whom access will be provided for those items of personal health data;
a health care provider providing authentication of their identity to the consumer's secure repository and being provided access to those items of personal health data of the consumer for which the health care provider has been identified for sharing;
the health care provider using the personal health data of the consumer to determine health care advice or the provision of a health care service for the consumer; and
the health care provider recording details of the consultation and the advice or service provided to the consumer in the secure repository of health data of the consumer.

2. The method of claim 1 wherein the selection of items of personal health data for sharing is effected by use of a template, the template comprising at least one pre-defined list of personal health data items that may be shared with a health care provider, or class of health care providers.

3. The method of claim 2 wherein the pre-defined template may be amended by the consumer in order to alter the selection of items of personal health data that may be shared with health care providers identified by that template.

4. The method of any one of the preceding claims wherein the selection of personal health data for purposes of sharing is effected by use of a filter wherein a set of conditions satisfied by personal health data of the consumer is shared with a health care provider or class of health care provider.

5. The method of any one of the preceding claims further comprising the step of recording all instances of actual access of the consumer's personal health data in order to generate an audit trail.

6. The method of claim 5 wherein the record of instances of access is included in a report to be supplied to the consumer.

7. The method of any one of the preceding claims further comprising the step of the consumer granting permission to a health care provider to add and share items of personal health data by enabling that health care provider to access the template that the consumer has defined for that health care provider, or class of health care provider.

8. The method of claim 7 wherein the health care provider is a physician and the items of personal data added by the physician to the consumer's health data repository comprise the details of a prescription.

9. The method of claim 2 or claim 3 wherein the template further defines restrictions or conditions relating to the sharing of personal health data.

10. The method of claim 9 wherein the template restricts access to personal health data to a limited period of time.

11. The method of any one of the preceding claims wherein a template is provided to perform functions on the underlying personal health data of a consumer.

12. The method of claim 11 wherein the template devolves medication and health information into data such that it may be presented to other users in an altered form.

13. The method of any one of the preceding claims wherein the health care provider is a pharmacist.

14. The method of any one of the preceding claims wherein the health data comprises a list of medication that the consumer is currently prescribed and medication that has previously been prescribed.

15. The method of any one of the preceding claims wherein the health care provider makes available a software program which is transferred into the secure repository of a consumer and which uses the personal health data for which access has been granted as input to the software program.

16. The method of claim 15 wherein an output of the software program also resides in the secure repository and is thus provided to the consumer.

17. The method of claim 15 or claim 16 wherein the output of the software program provides at least one of: advice to the consumer; a progress report with respect to some combination of items of personal health data; an alert or warning of an impending condition or circumstance that requires some form of intervention in order to avoid; details regarding the form of intervention required or choices in relation to the available types of intervention that may avoid a condition from developing; and recommendations regarding further actions to be performed or further health data that should be collected or analysed in order to provide decision support.

18. The method of any one of claims 15 to 17 wherein consumer consent is obtained prior to transferral of the software program into the secure repository.

19. The method of any one of the preceding claims wherein the secure repository of items of personal health data of consumers is provided by a third party.

20. The method of claim 19 wherein the third party is engaged to create links between personal health data items of the consumer in order to enable other users to efficiently access required personal health data items of the consumer.

21. The method of any one of the preceding claims wherein access to health data within the repository requires the use of a digital security key.

22. The method of claim 21 wherein the digital security key is supplied at the time the health care provider requests access to items of personal health data.

23. The method of any one of the preceding claims wherein the health data repository is connected to a computer communications network enabling all other permitted health care providers to connect to that network to gain access to the personal health data of a consumer.

24. The method of claim 23 wherein the repository is connected to the Internet.

25. The method of any one of the preceding claims wherein personal health data of a plurality of consumers is provided concurrently to a health care provider.

26. A system for a health care provider to obtain personal health data relating to a consumer, the system comprising:
a secure repository for the storage of a consumer's personal health data;
a means enabling the consumer to select items of personal health data that are to be shared with a health care provider, the means also enabling the consumer to identify the health care provider, or class of health care providers, to whom access will be provided for those selected items of personal health data;
means for authenticating the identity of health care providers and providing access to the selected items of personal health data of the consumer for which the health care provider has been identified as having permission to access; and
means for the health care provider to record details of the consultation in the consumers secure repository of health data.

27. The system of claim 26 wherein the means enabling the consumer to select items of personal health data that are to be shared comprises a template, the template comprising at least one pre-defined list of personal health data items that may be shared with a health care provider, or class of health care providers.

28. The system of claim 27 wherein the pre-defined list of the template may be amended by the consumer in order to alter the selection of items of personal health data that may be shared with health care providers identified by that template.

29. The system of any one of claims 26 to 28 wherein the means enabling the consumer to select items of personal health data that are to be shared comprises a filter, wherein a set of conditions of the filter defines a health care provider or class of health care provider with whom the selected items of personal health data are to be shared.

30. The system of any one of claims 26 to 29 further comprising means for recording all instances of actual access of the consumer's personal health data in order to generate an audit trail.

31. The system of claim 30 further comprising means for generating a report comprising recorded instances of access to be supplied to the consumer.

32. The system of any one of claims 26 to 31 further comprising means enabling the consumer to grant permission to a health care provider to add and share items of personal health data by enabling that health care provider to access the template that the consumer has defined for that health care provider, or class of health care provider.

33. The system of claim 32 wherein the health care provider is a physician and the items of personal data added by the physician to the consumer's health data repository comprise the details of a prescription.

34. The system of claim 27 or claim 28 wherein the template further defines restrictions or conditions relating to the sharing of personal health data.

35. The system of claim 34 wherein the template restricts access to personal health data to a limited period of time.

36. The system of any one of claims 26 to 35 wherein a template is provided to perform functions on the underlying personal health data of a consumer.

37. The system of claim 36 wherein the template devolves medication and health information into data such that it may be presented to other users in an altered form.

38. The system of any one of claims 26 to 37 wherein the health care provider is a pharmacist.

39. The system of any one of claims 26 to 38 wherein the health data comprises a list of medication that the consumer is currently prescribed and medication that has previously been prescribed.

40. The system of any one of claims 26 to 39 wherein the health care provider makes available a software program which is transferred into the secure repository of a consumer and which uses the personal health data for which access has been granted as input to the software program.

41. The system of claim 40 wherein an output of the software program also resides in the secure repository and is thus provided to the consumer.

42. The system of claim 40 or claim 41 wherein the output of the software program provides at least one of: advice to the consumer; a progress report with respect to some combination of items of personal health data; an alert or warning of an impending condition or circumstance that requires some form of intervention in order to avoid; details regarding the form of intervention required or choices in relation to the available types of intervention that may avoid a condition from developing; and recommendations regarding further actions to be performed or further health data that should be collected or analysed in order to provide decision support.

43. The system of any one of claims 40 to 42 wherein consumer consent is obtained prior to transferral of the software program into the secure repository.

44. The system of any one of claims 26 to 43 wherein the secure repository of items of personal health data of consumers is provided by a third party.

45. The system of claim 44 wherein the third party is engaged to create links between personal health data items of the consumer in order to enable other users to efficiently access required personal health data items of the consumer.

46. The system of any one of claims 26 to 45 wherein access to health data within the repository requires the use of a digital security key.

47. The system of claim 46 wherein the digital security key is supplied at the time the health care provider requests access to items of personal health data.

48. The system of any one of claims 26 to 47 wherein the health data repository is connected to a computer communications network enabling all other permitted health care providers to connect to that network to gain access to the personal health data of a consumer.

49. The system of claim 48 wherein the repository is connected to the Internet.

50. The system of any one of claims 26 to 49 wherein personal health data of a plurality of consumers is provided concurrently to a health care provider.
